(19) United States
(12) Patent Application Publication
(10) Pub. No.: US 2024/0377655 A1
(43) Pub. Date: Nov. 14, 2024

(54) SELECTIVE PHOTOCHROMIC LENS

(71) Applicant: LUXOTTICA S.R.L., AGORDO (BL) (IT)

(72) Inventors: Irene SEGNAN, TORINO (TO) (IT); Francesco BUTI, TORINO (TO) (IT)

(21) Appl. No.: 18/553,083

(22) PCT Filed: Mar. 24, 2022
(86) PCT No.: PCT/IB2022/052694

§ 371 Date: Sep. 28, 2023

(30) Foreign Application Priority Data
Mar. 31, 2021 (IT) 102021000008015

(51) Int. Cl. G02C 7/10; B29D 11/00

(52) U.S. Cl. CPC G02C 7/102; B29D 11/00317; B29D 11/00653; B29D 11/00865; G02C 7/105

(57) ABSTRACT

A photochromic lens for glasses, including photochromic dyes, wherein the photochromic dyes are suitable for passing from a not activated state to an activated state. The activated state of the photochromic dyes provides that photochromic dyes change color when hit by an electromagnetic radiation. The photochromic lens includes at least a first portion and at least a second portion, wherein the first portion has a reflecting material coating reflecting the electromagnetic radiation, and the second portion is devoid of the coating. The photochromic lens has a first surface with at least a first portion and at least a second portion, wherein the first surface faces outward from the glasses, outward meaning a direction with respect to the photochromic lens mounted on a glasses frame.

### CROSS-REFERENCE TO RELATED APPLICATIONS

This application is a 35 U.S.C. § 371 National Stage patent application of PCT/IB2022/052694, filed on 24 Mar. 2022, which claims the benefit of Italian patent application 102021000008015, filed on 31 Mar. 2021, the disclosures of which are incorporated herein by reference in their entirety.

### TECHNICAL FILED

The present disclosure relates to a selective photochromic lens.

### BACKGROUND

In the state of the art, photochromic lenses for glasses comprising photochromic dyes are known, wherein said photochromic dyes are adapted to pass from an unactivated state to an activated state, wherein said activated state of said photochromic dyes requires the photochromic dyes to change when hit by ultraviolet radiation.

For example EP2513713B1 describes a photochromic lens comprising two layers, a transparent substrate, a saturated photochromic layer having, in its UV activated state and at a temperature of 20° C., a relative transmittance factor of less than 1% in the visible range and an anti-UV coating of plastic material at least partially covering the saturated photochromic layer. UV radiation is absorbed so that the photochromic effect of the lens reduces its dependence on ambient temperature.

Disadvantageously, the whole photochromic lens changes colour when ultraviolet rays affect the photochromic dyes, making it impossible to make portions of the photochromic lens that do not change colour.

### SUMMARY

The present disclosure provides a photochromic lens comprising at least one photochromic portion and at least one non-photochromic portion.

In accordance with the disclosure, this is achieved by providing a photochromic lens according to claim 1.

The present disclosure further provides a process for making a photochromic lens comprising at least one photochromic portion and least at another non-photochromic portion.

According to the disclosure, such other advantage is achieved by providing a method according to claim 4.

Other features are provided in the dependent claims.

### BRIEF DESCRIPTION OF THE DRAWINGS

The features and advantages of the present disclosure will be more apparent from the following description, which is to be understood as exemplifying and not limiting, with reference to the appended schematic drawings, in which:

FIG. 1 is a schematic front view of a photochromic lens according to the present disclosure comprising a first non-photochromic portion and a second photochromic portion;

FIG. 2 is a schematic cross-sectional view of a transverse portion of the photochromic lens according to the lines II-II in FIG. 1; and

FIG. 3 is a schematic cross-sectional view of the photochromic lens according to the present disclosure during an operation of a process for making said photochromic lens comprising coating the non-photochromic portion with a removable protective layer.

### DETAILED DESCRIPTION OF THE DRAWINGS

With reference to the above figures, a photochromic lens 10 for glasses comprising photochromic dyes 15 is shown (in the figures, the size of the dyes and coatings are deliberately exaggerated), wherein said photochromic dyes 15 are adapted to change from an unactivated state to an activated state, wherein said activated state of said photochromic dyes 15 provides that said photochromic dyes 15 change colour when hit by electromagnetic radiation.

Preferably the electromagnetic radiation is ultraviolet radiation.

The technology of photochromic lenses 10 is already known and will not be described further. It is in no way intended to limit the disclosure to existing photochromic lens solutions, it being understood that the present disclosure may equally be applied to other types of photochromic lenses to be developed in the future.

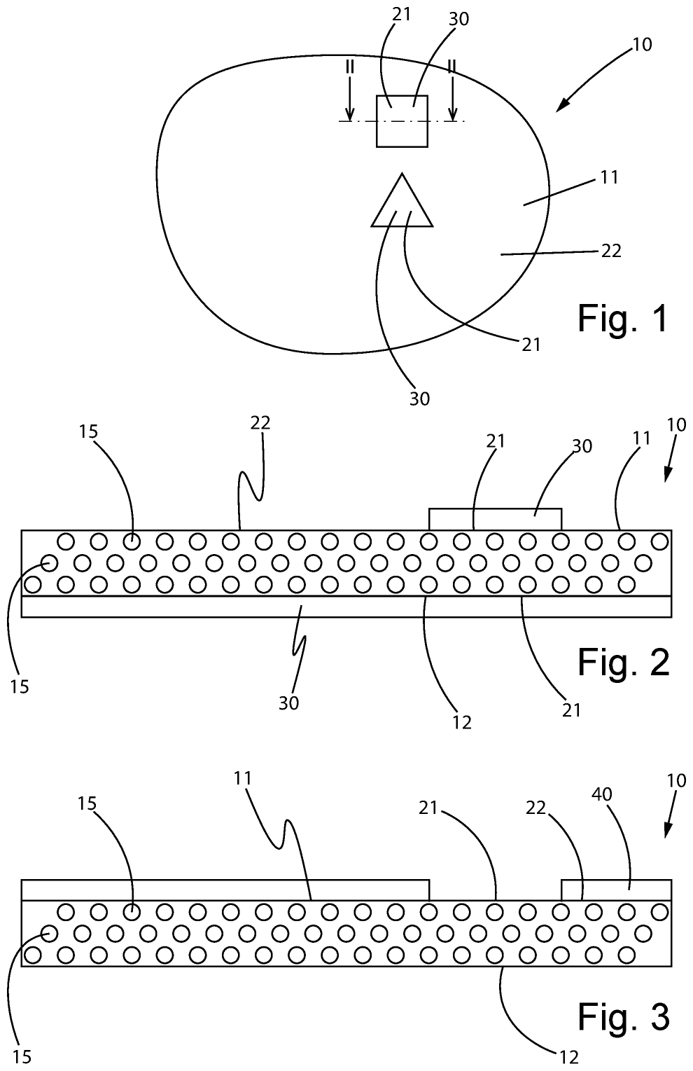

As shown in FIGS. 1 and 2, said photochromic lens 10 comprises a first portion 21 and a second portion 22.

Said first portion 21 comprises a coating 30 of reflective material reflecting said electromagnetic radiation, while said second portion 22 is devoid of said coating 30.

As shown in particular in FIGS. 1 and 2, the photochromic lens 10 comprises a first surface 11 comprising said first portion 21 and a second portion 22 and a second surface 12 comprising another first portion 21.

The first surface 11 is the surface of the photochromic lens 10 facing outwards from the glasses, where outward means a direction relative to the photochromic lens 10 mounted with a glasses frame and worn by a person wearing the glasses.

The second surface 12 faces inward of the glasses when the photochromic lens 10 is mounted with the glasses frame, where inward means facing a face of a person wearing the glasses.

Advantageously, the first surface 11 comprises both the first non-photochromic portions 21 and the second photochromic portion 22.

Advantageously, the first portion 21 may be shaped to form drawings or inscriptions that are only visible when the second portion 22 changes colour due to the incidence of the selected electromagnetic rays.

Advantageously, the coating 30 of the second surface 12 prevents the photochromic lens 10 from changing colour due to the glare of electromagnetic radiation reflected from a face of the person wearing the glasses.

Said coating 30 is a multilayer comprising at least a first layer facing outward from said lens and at least a second layer facing inward of said lens, wherein said at least one first layer has a low refractive index, wherein said at least one second layer has a high refractive index. Outward and inward means in relation to the photochromic lens frame 10 with the glasses frame.

In particular, the coating 30 is a so-called AR-UV cut 400, which is a multilayer coating with the following structure: substrate\(HL)n\Air, wherein H is the second high refractive index layer and L is the first low refractive index layer and wherein the substrate is one of the surfaces 11, 12 wherein the first non-photochromic portion 21 is provided.

Multilayer comprises several layers H and L on top of one other and alternating with one other.

This process advantageously reflects the electromagnetic radiation, preventing the activation of the photochromic dyes 15.

For example, said at least one first layer is magnesium difluoride and said at least one second layer is zirconium dioxide.

Even more advantageously and preferably said at least one first layer is silicon dioxide and said at least one second layer is titanium oxide. Silica and titanium can be used advantageously at low ambient temperatures, whereas other materials require high temperatures.

With respect to the process for making said photochromic lens 10 for glasses according to the present disclosure, it is contemplated that said process comprises a succession of operations.

Preferably these operations are in chronological order.

The process comprises an operation A providing coating said at least a second portion 22 by a removable protective layer 40.

This first operation is preferably carried out by tampoprinting or pad printing.

Tampoprinting is a process of transferring a 2-D image onto 3-D objects. This is achieved by transferring an image from a plate via a silicone pad onto a substrate. In this case, the substrate is one of the surfaces 11, 12 of the photochromic lens 10.

A cup of ink sits on an area of photo-etched graphics on a printing plate, covering the image and filling it with ink.

The sealed ink cup moves away from the engraved design area, taking all the excess ink and exposing the engraved image, which is full of ink.

The transfer pad presses on the printing plate.

When the transfer pad is lifted, the sticky ink film inside the engraved decoration area is collected on the pad.

The transfer pad is compressed on the substrate, transferring the layer of ink collected from the printing plate to the surface of the substrate.

The process comprises an operation B providing coating said at least a first portion 21 by said coating 30.

Preferably, the operation B is carried out subsequent to the operation A.

Preferably, said operation B is carried out by depositing said reflective material under conditions of low pressure and medium temperature.

Low pressure means values comprised between 0.50*10⁻² Pa and 2.50*10⁻³ Pa.

Medium temperature means values comprised between 0° C. and 250° C.

Even more preferably, said second operation is carried out by physical vapour deposition, usually referred to as PVD.

PVD processes using an electromagnetic gun known as an EB-gun are usually divided into the following steps.

A machine creates a closing vacuum to achieve the minimum deposition pressure of around 2.50*10⁻³ Pa. When the pressure reaches 1.00*10³ Pa, a so-called Meissner trap begins to freeze and reaches −100° C. When the pressure reaches 1.00*10⁻², Argon gas flows through a beam of the ion source, ignites, excites and neutralises the gas that would otherwise hit the evaporating materials. Once the coupling time has elapsed, the Argon gas valve closes and the vacuum decreases to 2.00*10⁻³ Pa. The EB-gun then ignites, heats the materials in the crucible and evaporates them when the shutter opens. When the deposition of the reflective material on said at least a first portion 21 of the photochromic lens 10 is complete, the shutter closes and the crucible turns for the next well. Finally, when the last layer of coating 30 has been deposited, the high vacuum plate closes and the Meissner trap begins to heat up to an external ambient temperature comprised between 15 and 35° C. The pressure starts to increase to 1.00*10² Pa, finally the vent valve opens.

The process comprises an operation C providing removing said removable protective layer 40 from said second portion 22.

Preferably said operation C is subsequent to the operation B.

Preferably said operation C involves removing the removable protective layer by at least one bath in a chemical mixture.

Preferably said operation C comprises at least a first step providing washing said photochromic lens 10 in a first bath comprising a first mixture comprising water and at least one basic detergent. Said third operation comprises at least a second step subsequent to said at least a first step providing rinsing said photochromic lens 10 to remove said at least one basic detergent.

Said third operation comprises at least a third step subsequent to said at least a second step providing drying said photochromic lens 10.

Even more preferably, it is envisaged that said third operation should comprise at least two of said first stages and at least two of said second stages.

For the first step, a wash tank containing a 10% aqueous solution of highly basic detergent with a pH close to 12, GLR, is provided. These tanks heat the solution to 45° C. and require water to replace the evaporated water. The solution is prepared once it has been used up.

For the second step, a rinsing tank containing untreated industrial water is provided to advantageously remove at least part of the detergent residue.

The first and second steps of operation C correspond to a bath and rinse cycle that can be repeated several times in succession.

If the cycle comprises several first and second steps, a second washing tank is provided in which the photochromic lens samples 10 pass a second first step of a highly basic GLR detergent.

In succession there is a second rinsing step followed even more preferably by a multiple step of immersion in demineralized water.

Said basic detergent preferably has a pH between 11 and 13.

Advantageously, the photochromic lens 10 of the present disclosure comprises at least one second photochromic portion 22 and at least one first non-photochromic portion 21.

Alternatively, the wavelength of the electromagnetic radiation to activate the photochromic dyes 15 of the photochromic lens can be expected to assume different values depending on the colour of the lens.

Alternatively, it may be provided that the basic detergent is different for each bath of the first step of the rinse bath cycle of the process for making the photochromic lens 10 of the present disclosure.

The disclosure thus conceived is susceptible to many modifications and variants, all falling within the same inventive concept. In practice, the materials used, as well as their dimensions, can be of any type according to the technical requirements.

1. A photochromic lens for glasses, comprising photochromic dyes,
wherein said photochromic dyes are suitable for passing from a not activated state to an activated state,
wherein said activated state of said photochromic dyes provides that photochromic dyes change color when hit by an electromagnetic radiation,
wherein said photochromic lens comprises at least a first portion and at least a second portion,
wherein said at least a first portion provides a reflecting material coating reflecting said electromagnetic radiation,
wherein said at least a second portion is devoid of said coating,
wherein said photochromic lens provides a first surface comprising said at least a first portion and said at least a second portion, and
wherein said first surface faces outward from the glasses, outward meaning a direction with respect to the photochromic lens mounted on a glasses frame.

2. The photochromic lens according to claim 1, wherein said coating is a multilayer coating comprising at least a first layer facing the outside of said lens and at least a second layer facing the inside of said lens,
wherein said at least a first layer is a low refraction index layer, and
wherein said at least a second layer is a high refraction index layer.

3. The photochromic lens according to claim 2, wherein said at least a first layer is comprised of silicon dioxide and in that said at least a second layer is comprised of titanium oxide.

4. A method for manufacturing a photochromic lens for glasses,
wherein said photochromic lens is a lens according to claim 1,
and said method includes the following steps:
an operation A providing coating said at least a second portion by a removable protective layer,
an operation B providing coating said at least a first portion by said coating, and
an operation C providing removing said removable protective layer from said second portion.

5. The method according to claim 4, wherein said operation A is carried out by a “tampoprinting” technique.

6. The method according to any one of the preceding claim 4, wherein said operation B is carried out by depositing said reflecting material under low pressure and medium temperature conditions, wherein low pressure values range between 0.50*10⁻² Pa and 2.50*10⁻³ Pa and low temperature values range between 0° C. and 250° C.

7. The method according to claim 5, wherein said operation B is carried out by physical vapour deposition.

8. The method according to claim 4, wherein said operation C provides removing said removable protective layer by a bath into a chemical mixture.

9. The method according to claim 8, wherein said operation C comprises:
at least a first step providing washing said photochromic lens in a first bath comprising a first mixture comprising water and at least one basic detergent,
at least a second step subsequent to said at least a first step providing rinsing said photochromic lens to remove said at least one basic detergent, and
at least a third step subsequent to said at least a second step providing drying said photochromic lens.

10. The method according to claim 9, wherein two of said first steps and two of said second steps are provided.
